(19) United States
(12) Patent Application Publication
(10) Pub. No.: US 2024/0048853 A1
(43) Pub. Date: Feb. 8, 2024

(54) Pulsed-Light Optical Imaging Systems for Autonomous Vehicles

(71) Applicant: Motional AD LLC, Boston, MA (US)

(72) Inventor: Kiat Choon Teo, Singapore (SG)

(21) Appl. No.: 17/817,203

(22) Filed: Aug. 3, 2022

(51) Int. Cl. H04N 5/235; G06T 7/70; B60W 60/00; B60Q 1/24; B60W 40/04; G01S 7/484; G01S 17/931

(52) U.S. Cl. CPC H04N 5/2354; H04N 5/2351; G06T 7/70; B60W 60/001; B60Q 1/249; B60W 40/04; G01S 7/484; G01S 17/931; G06T 2207/30261; B60W 2420/42; B60W 2420/52; B60W 2554/80; B60W 2520/00; G01S 13/865

(57) ABSTRACT

Provided are example systems for obtaining optical sensor data to facilitate the operation of an autonomous vehicle. In an example implementation, a system includes a light source, an optical sensor, and a control module. The light source periodically emits pulses of light into the environment of the autonomous vehicle. The optical sensor periodically obtains optical sensor data of the environment of the autonomous vehicle. The control module obtains additional sensor data from one or more additional sensors, the additional sensor data representing at least one of a characteristic of the autonomous vehicle or a characteristic of the environment of the autonomous vehicle, and controls an operation of the light source based on the additional sensor data.

### BACKGROUND

In general, autonomous vehicles obtain sensor data to determine characteristics of the environment and control vehicle operations. As an example, an autonomous vehicle obtains sensor data to determine the location of an obstacle in the environment, and navigate around the obstacle.

### BRIEF DESCRIPTION OF THE FIGURES

FIG. 1 is an example environment in which a vehicle including one or more components of an autonomous system can be implemented.

FIG. 2 is a diagram of one or more systems of a vehicle including an autonomous system.

FIG. 3 is a diagram of components of one or more devices and/or one or more systems of FIGS. 1 and 2.

FIG. 4 is a diagram of certain components of an autonomous system.

FIG. 5 is a diagram of an example optical imaging system.

FIG. 6 is a diagram of an example operation of an optical imaging system.

FIGS. 7A and 7B are diagrams of another example operation of an optical imaging system.

FIGS. 8A and 8B are diagrams of another example operation of an optical imaging system.

FIGS. 9A and 9B are diagrams of another example operation of an optical imaging system.

FIGS. 10A and 10B are diagrams of another example operation of an optical imaging system.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Some embodiments of the present disclosure are described herein in connection with a threshold. As described herein, satisfying a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, the systems described herein obtain optical sensor data to facilitate the operation of an autonomous vehicle.

In an example embodiment, a vehicle (e.g., an autonomous vehicle) includes various sensors for detecting the characteristics of its environment. Further, the vehicle uses the sensor data to identify objects in the environment (also referred to as “object detection”) and to determine the vehicle's position and orientation within the environment (also referred to as “localization”).

Further, the vehicle obtains sensor data using an optical imaging system that includes a pulsed light source and an optical sensor. During operation of the optical imaging system, the pulsed light source periodically emits pulses of light into the environment (e.g., to periodically illuminate objects in the environment) and the optical sensor obtains imaging data regarding the environment using the pulses of light. In some implementations, the optical imaging system varies the characteristics of the pulses of light that are emitted by the pulsed light source based on sensor data obtained by the optical imaging system and/or other sensors (also referred to as “sensor fusion”).

The implementations described herein provide various technical benefits. For instance, in at least some implementations, the optical imaging system enables a vehicle to obtain sensor data regarding its environment in low light conditions or no light conditions (e.g., complete darkness) and in a computationally cost-effective manner. As an example, the pulsed light source enable the optical sensor data to capture images that are sharper and clearer than would otherwise be possible in low light conditions or no light conditions, absent use of the pulsed light source. Accordingly, the vehicle can perform object detection and/or localization more accurately. As another example, in some implementations, the vehicle uses the optical imaging system to perform object detection and/or localization without the use of a LiDAR sensor. This is advantageous, as LiDAR sensors may be more expensive and/or complex to implement in a vehicle (e.g., compared to an optical imaging system). Nevertheless, in some implementations, the vehicle uses the optical imaging system in conjunction with LiDAR sensors and/or other sensor systems to perform object detection and/or localization (e.g., to increase the diversity of sensor data collected by the vehicle during operation).

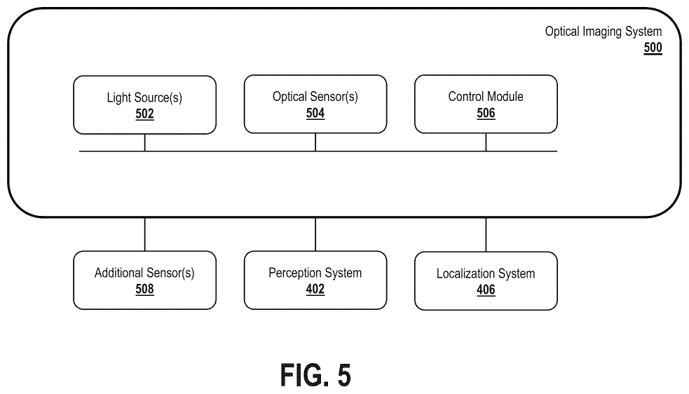

Example optical imaging system are described in further detail with reference to FIGS. 5-10B.

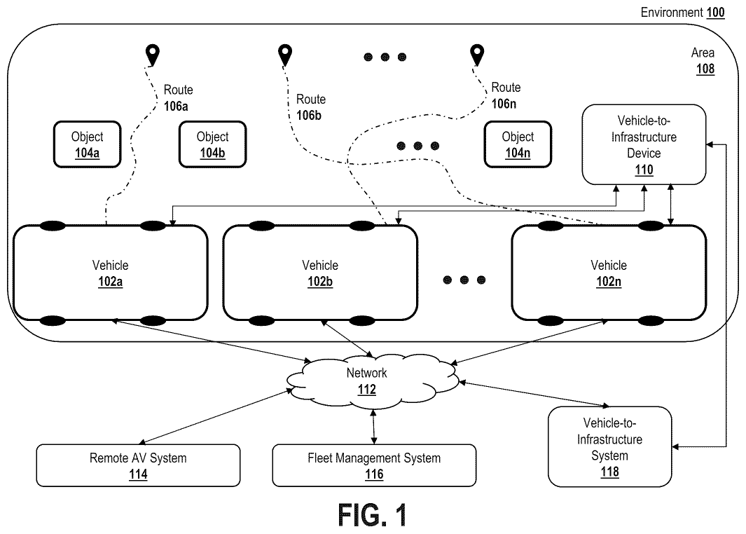

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, remote autonomous vehicle (AV) system 114, fleet management system 116, and V2I system 118 via wired connections, wireless connections, or a combination of wired or wireless connections.

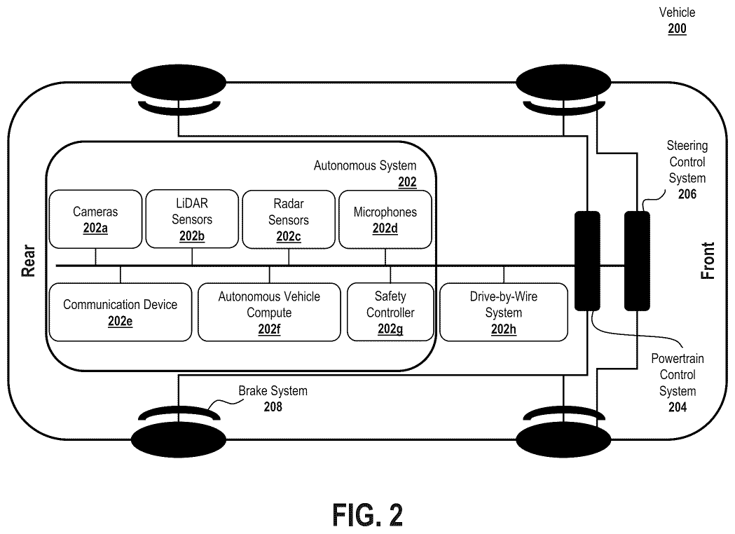

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one drive automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like.

In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

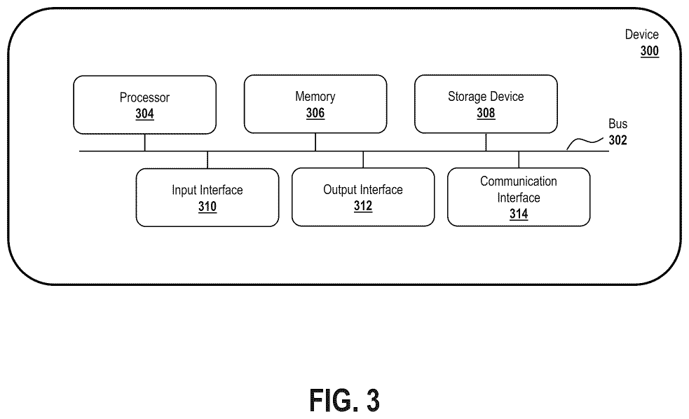

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of vehicle 200 (e.g., at least one device of a system of vehicle 200), and/or one or more devices of network 112 (e.g., one or more devices of a system of network 112). In some embodiments, one or more devices of vehicles 102 (e.g., one or more devices of a system of vehicles 102), one or more devices of vehicle 200 (e.g., one or more devices of a system of vehicle 200), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, a processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

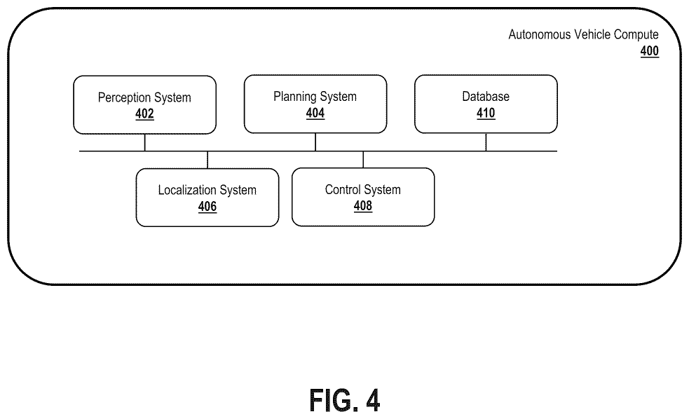

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), Arithmetic-Logic Units (ALUs), Systems on a Chip (SOCs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Example Pulsed-Light Optical Imaging Systems

A vehicle (e.g., an autonomous vehicle) includes various sensors for detecting the characteristics of its environment. As an example, a vehicle obtains sensor data (e.g., optical sensor data, radar data, LiDAR data, etc.) as the vehicle traverses through an environment. Further, the vehicle uses the sensor data to identify objects in the environment (also referred to as “object detection”) and to determine the vehicle's position and orientation within the environment (also referred to as “localization”).

As examples, characteristics of the environment include a presence (or absence) of one or more locations of objects in the environment, the location of those objects relative to the vehicle, and the physical shape or boundaries of the objects. As another example, characteristics of the environment include an amount of light in the environment (e.g., ambient light and/or light produced by artificial sources, such as lamps). As another example, characteristics of the environment include a geographical location of the environment and/or the geographical location one or more of points of interest in the environment.

Further, a vehicle includes various sensors for detecting characteristics of the vehicle itself. As examples, characteristics of the vehicle include the speed or velocity of the vehicle, the trajectory of the vehicle, the acceleration or braking of the vehicle, the orientation of the vehicle.

In some implementations, the vehicle determines the characteristics of the environment and/or the characteristics of the vehicle using one or more sensors. As described above (e.g., with reference to FIG. 2), example sensors include cameras 202a, LiDAR sensors 202b, radar sensors 202c, and microphones 202d).

In some implementations, a vehicle also obtains sensor data using an optical imaging system that includes a pulsed light source and an optical sensor. During operation of the optical imaging system, the pulsed light source periodically emits pulses of light into the environment (e.g., to periodically illuminate objects in the environment) and the optical sensor obtains imaging data regarding the environment using the pulses of light.

In some implementations, the optical imaging system varies the characteristics of the pulses of light that are emitted by the pulsed light source based on sensor data obtained by the optical imaging system and/or other sensors (also referred to as “sensor fusion”). As an example, the optical imaging system varies the power and/or intensity of the pulses of light based on the distance between the autonomous vehicles and objects in the environment (e.g., as determined by a radar system or other ranging system). As another example, the optical imaging system varies the frequency of the pulses of light based on the distance between the autonomous vehicles and points of interest (e.g., as determined by a navigation or mapping system). As another example, the optical imaging system selectively switches the pulsed light source on or off depending on the ambient light in the environment (e.g., as determined by an ambient light sensor) and/or the velocity of the vehicle (e.g., as determined by a velocity sensor).

The implementations described herein provide various technical benefits. For instance, in at least some implementations, the optical imaging system enables a vehicle to obtain sensor data regarding its environment in low light conditions or no light conditions and in a computationally cost-effective manner.

As an example, the pulsed light source periodically emits pulses of light into an environment, such that there is sufficient light to capture high fidelity option sensor data of the environment in low light conditions or no light conditions (e.g., complete darkness). In particular, the pulses of light enable the optical sensor data to capture images that are sharper and clearer than would otherwise be possible in low light conditions or no light conditions, absent use of the pulsed light source. Accordingly, the vehicle can perform object detection and/or localization more accurately.

Further, in some implementations, the vehicle uses the optical imaging system to perform object detection and/or localization without the use of a LiDAR sensor. This is advantageous, as LiDAR sensors may be more expensive and/or complex to implement in a vehicle (e.g., compared to an optical imaging system). Nevertheless, in some implementations, the vehicle uses the optical imaging system in conjunction with LiDAR sensors and/or other sensor systems to perform object detection and/or localization (e.g., to increase the diversity of sensor data collected by the vehicle during operation).

An example optical imaging system 500 is shown in FIG. 5. The optical imaging system 500 includes one or more light sources 502, one or more optical sensors 504, and a control module 506. Further, the optical imaging system 500 is communicatively coupled to one or more additional sensors 508, a perception system 402, and a localization system 406.

In general, at least a portion of the optical imaging system 500 is deployed on a vehicle 200. For example, the light source(s) 502 are positioned on the vehicle 200, such that they direct light towards toward the environment 650 surrounding a vehicle 200 (e.g., towards the front, sides, and/or rear of the vehicle 200). As another example, the optical sensor(s) 504 are positioned on the vehicle 200, such that they receive light from the environment 650 (e.g., from the front, sides, and/or rear of the vehicle 200). In some implementations, the control module 506 is also positioned on the vehicle 200. In some implementations, the control module 506 is positioned remote from the vehicle 200, and is communicatively coupled to the vehicle 200, the light source(s) 502, and the optical sensor(s) 504 (e.g., via a communications network).

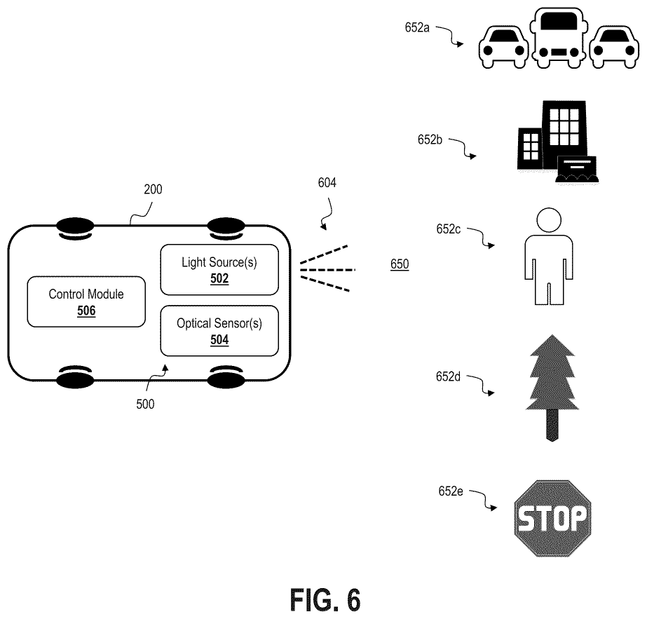

Referring to FIG. 6, during an example operation of the optical imaging system 500, the light source(s) 502 periodically emit pulses of light 604 into the environment 650. At least some of the pulses of light 604 reflect and/or scatter from one or more objects or features of the environment 650, and return to the optical sensor(s) 504. Example objects or features of the environments 650 include other vehicles 652a (e.g., cars, trucks, vans, motorcycles, bicycles, etc.), buildings or structures 652b, pedestrians 652c, natural objects or bodies 652d (e.g., animals, plants, landforms, bodies of water, etc.), traffic control devices 652e (e.g., traffic signals, signals, line markings, etc.), and/or any other object or feature that may be present in the environment 650.

The optical sensor(s) 504 receive at least some of the light from the environment 650, and generate optical sensor data representing the environment 650. Example optical sensor data includes images, videos, or a combination thereof. In some implementations, the pulses of light emitted by the light source(s) 502 facilitate the generation of high fidelity optical sensor data in low light conditions or no light conditions (e.g., at night, in a poorly illuminated tunnel, building, or other structure, etc.).

Referring back to FIG. 5, the optical sensor data is provided to the perception system 402 (e.g., to facilitate the identification of objects in the environment) and to the localization system 406 (e.g., to facilitate the determination of the vehicle's position and orientation within the environment). For example, based on the optical sensor data, the perception system 402 identifies one or more of the objects or features 652a-652e, and classifies the one or more of the objects or features 652a-652e according to respective types or classes (e.g., as described with reference to FIG. 4). As another example, based on the optical sensor data, the localization system 406 determines the vehicle's positon and orientation relative to each of the objects or features 652a-652e and/or determines a geographical location of the vehicle 200 (e.g., as described with reference to FIG. 4).

In general, the light source(s) 502 can include any component or mechanism for emitting light. As an example, each of the light source(s) 502 can include one or more light emitting diodes (LEDs), xenon lamps, halogen lamps, incandescent lamps, compact fluorescent lamps (CFLs), and/or any other light emitting device. Further, the light source(s) 502 can include one or more lenses for directing and/or focusing the emitted light towards the environment 650 (e.g., a Fresnel lens).

Further, the light source(s) 502 can be configured to emit light according to any wavelength. In some implementations, at least some of the light source(s) 502 are configured to emit light in the visible spectrum (e.g., the portion of the electromagnetic spectrum that is visible to the human eye), such as light having wavelengths of about 400 to about 700 nm. In some implementations, at least some of the light source(s) 502 are configured to emit light in the ultraviolet spectrum, such as light having wavelengths of about 10 nm to about 400 nm. In some implementations, at least some of the light source(s) 502 are configured to emit light in the infrared spectrum, such as light having wavelengths of about 700 nm to about 1 mm. In some implementations, at least some of the light source(s) 502 are configured to emit light in a combination of the visible spectrum, the ultraviolet spectrum, and/or infrared spectrum.

As an example, in some implementations, the light source(s) 502 is configured to emit light having wavelengths between 400 nm to 650 nm. Other wavelengths of light are also possible, depending on the implementation.

Further, the light source(s) 502 are configured to periodically emit pulses of light according to a particular temporal pattern. As an example, the light source(s) 502 can be configured to emit pulses of light according to a particular frequency, duration, and duty cycle. The frequency of emission refers to the frequency at which light is emitted by the light source(s) 502 (e.g., the inverse of the time interval between the beginning of successive pulses of light). The duration refers to the length of time between the beginning of a light pulse and an end of the light pulse. The duty cycle refers to the fraction of time that the light source(s) are active (e.g., emitting light). The frequency, duration, and/or duty cycle can be selected (e.g., by the control module 506) based on the optical sensor data and/or sensor data from one or more additional sensor(s) 508, as described in further detail below. In some implementations, the light source(s) 502 are configured to emit pulses of light having a duration of 1/20,000 s to 1/400 s. In some implementations, the light source(s) 502 are configured to emit pulses of light according to a frequency of less than 1 Hz, 1 Hz, 5 Hz, 10 Hz, 15 Hz, 20 Hz, or any other frequency. In some implementations, the light source(s) 502 are configured to emit pulses of light according to a duty cycle of less than 1%, 1%, 5%, 10%, 15%, 20% or any other duty cycle. In practice, other durations, frequencies, and/or duty cycles are possible, depending on the implementation.

As an example, in some implementations, the light source(s) 502 is configured to emit light according to a duration of 50 μs to 100 μs. As another example, in some implementations, the light source(s) 502 is configured to emit light according to a duration of 10 μs to 2000 μs. Other durations are also possible, depending on the implementation.

Further, the light source(s) 502 are configured to emit pulses of light according to a particular power or intensity. As an example, the light source(s) 502 can be configured to emit pulses of light according to low power or intensity (e.g., such that a small amount of light is emitted into the environment 650). As an example, the light source(s) 502 can be configured to emit pulses of light according to high power or intensity (e.g., such that a large amount of light is emitted into the environment 650). The intensity or power can be selected (e.g., by the control module 506) based on the optical sensor data and/or sensor data from one or more additional sensor(s) 508, as described in further detail below. In some implementations, the light source(s) 502 are configured to emit pulses of light according to a power of 150 Ws to 6000 Ws. In practice, other powers or intensities are possible, depending on the implementation.

In general, the optical sensor(s) 504 can include any component or mechanism for generating optical sensor data, such as videos, images, or a combination thereof. As an example, each of the optical sensor(s) 504 can include one or more photodetectors or image sensors, such as charge-coupled devices (CCDs), complementary metal-oxide-semiconductor (CMOS) sensors, or any other device for generating optical sensor data. Further, the optical sensor(s) 504 can include one or more lenses for directing and focusing light from the environment onto a photodetector or image sensor.

In some implementations, the optical sensor(s) 504 can be configured to obtain sensor data representing light detected by the optical sensor(s) 504 in the visible spectrum, the ultraviolet spectrum, or infrared spectrum, or any combination thereof.

Further, the optical sensor(s) 504 are configured to generate optical sensor data according to a particular temporal pattern. As an example, the light source(s) 502 can be configured to generate optical sensor data according to a particular frame rate or frequency. As another example, the optical sensor(s) 504 are configured to generate optical sensor data by collecting light over a particular interval of time (e.g., a particular shutter speed or exposure time). Further, the optical sensor(s) 504 are configured to generate optical sensor data by collecting light using a lens having a particular aperture and/or focal length (e.g., to control the amount of light that reaches a photodetector or image sensor). In some implementations, the lens may have an adjustable aperture and/or focal length. Each of these parameters can be selected (e.g., by the control module 506) based on the optical sensor data and/or sensor data from one or more additional sensor(s) 508, as described in further detail below.

In general, the emission of periodic pulses of light by the light source(s) 502 provide various technical benefits. For example, by emitting periodic pulses of light, the light source(s) can effectively “freeze” a subject in time for the purposes of obtaining optical sensor data using the optical sensor(s) 504. For example, in a low light environment, little or no ambient light reflects or scatters from a subject towards the optical sensor(s) 504 (and correspondingly, little or no optical sensor data regarding the subject is collected by the optical sensor(s) 504). However, when the light source(s) 502 emits a pulse of emit at a particular time and according to a particular duration (e.g., from times t₁ to t₂), the pulse of light reflects or scatters from the subject and towards the optical sensor(s) 504, with the reflected or scattered light representing the characteristics of the subject from time t₁ to time t₂ (accounting to the travel time of light to and from the subject) Accordingly, by emitting pulses of light according to a short time duration, the optical imaging system 500 can reduce the presence of motion blur in the captured optical sensor data, thereby resulting in sharper and clearer optical sensor data.

In general, the control module 506 controls the operations of the light source(s) 502 and the optical sensor(s) 504 based on optical sensor data obtained by the optical sensor(s) 504 and/or sensor data obtained by one or more additional sensor(s) 508. The control module 506 is implemented, for example, using one or more devices 300, as shown and described with reference to FIG. 3.

As an example, the control module 506 can be configured to select the wavelength(s) of pulses of light emitted by the light source(s) 502, the frequency by which the pulses of light of emitted, the duty cycle of the pulses of light, the duration of each of the pulses of light, and/or the power or intensity of each of the pulses of light.

As another example, the control module 506 can be configured to select the frame rate or frequency at which optical sensor data is obtained by the optical sensors(s) 504, the aperture of a lens of the optical sensor(s) 504, and/or a focal length of a lens of the optical sensor(s) 504.

In some implementations, the control module 506 synchronizes the emission of pulses of light by the light source(s) 502 with the collection of optical sensor data by the optical sensor(s) 504. For example, the control module 506 can instruct the light source(s) 502 to emit light during certain time intervals, and instruct the optical sensor(s) 504 to collect optical sensor data, at least in part, during the same time intervals. As another example, the control module 506 can instruct the light source(s) 502 to emit light according to a certain frequency, and instruct the optical sensor(s) 504 to collect optical sensor data according to the same or a similar frequency.

In some implementations, the control module 506 controls the emission of pulses of light by the light source(s) 502 and the collection of optical sensor data by the optical sensor(s) 504, such that the “exposure” of optical sensor data is suitable to discern details regarding the environment. For example, the control module 506 can select a set of parameters for emitting light (e.g., frequency, duty cycle, duration, power, intensity, etc.) and a set of parameters for collecting optical sensor data (e.g., shutter speed, exposure time, frequency, focal length, aperture, etc.), such that the collected optical sensor data is within (or is predominantly within) a dynamic range of the optical sensor(s) 504.

In some implementations, the control module 506 controls the emission of pulses of light based on a distance between one or more objects in the environment 650 and the vehicle 200. For instance, based on sensor data obtained from the additional sensor(s) 508 (e.g., radar sensor data obtained by one or more radar sensors 202c), the control module 506 can determine the distance between an object in the environment 650 and the vehicle 200. Further, the control module 506 can control the power of intensity of the emitted pulses of light based on the distance.

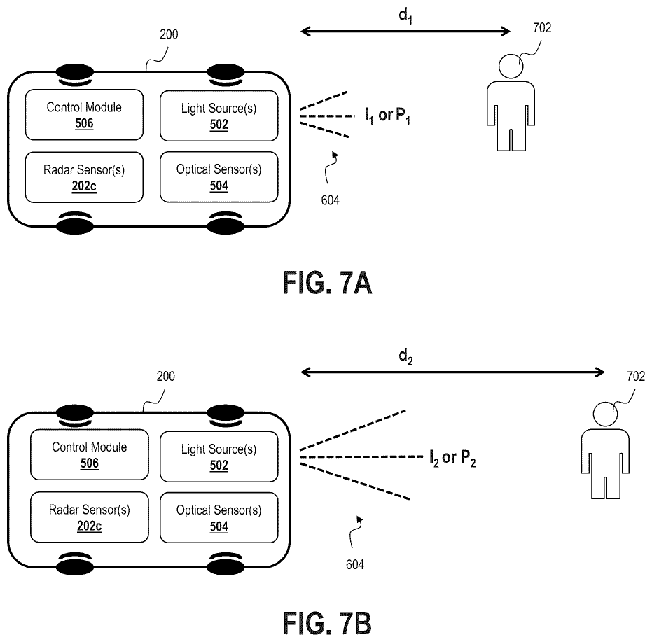

As an example, referring to FIG. 7A, the control module 506 obtains radar sensor data from the radar sensor(s) 202c, and determines that a subject 702 is positioned a distance d₁ from the front of the vehicle 200. Based on this determination, the control module 506 instructs the light source(s) 502 to emit pulses of light 602 according to a first intensity I₁ and/or according to a first power P₁.

Further, referring to FIG. 7B, the control module 506 obtains radar sensor data from the radar sensor(s) 202c, and determines that a subject 702 is now positioned a farther distance d₂ from the front of the vehicle 200. Based on this determination, the control module 506 instructs the light source(s) 502 to emit pulses of light 602 according to a second intensity I₂ greater than the first intensity I₁ and/or according to a second power P₂ greater than the first power P₁.

This technique is beneficial, for example, in improving the clarity and sharpness of the optical imaging data with respect to the subject 702. For example, if a subject is positioned close to the vehicle 200, low intensity and/or low power light may be sufficient to illuminate the subject 702. However, if a subject is positioned far from the vehicle 200, high intensity and/or high power light may be needed to illuminate the subject 702 to a similar degree. Accordingly, the control module 506 can selectively control the intensity and/or power of the emitted light, based on the distance of the subject 702 to the autonomous vehicle 200, to better collect optical sensor data regarding the subject 702.

In some implementations, distance between the subject 702 and the vehicle 200 is inversely proportional to the intensity and/or the power of the emitted light. In some implementations, distance between the subject 702 and the vehicle 200 is inversely proportional to the square of the intensity and/or the square of power of the emitted light.

Although radar sensor(s) 202c are describe with reference to FIGS. 7A and 7B, in practice, other sensors also could be used to determine a distance between a subject and the vehicle, either in addition to or instead of radar sensor(s) 202c. Example sensors include time of flight (ToF) sensors, sonar sensors, ultrasonic sensors, Doppler effect sensors, or any other sensors for determining a distance between two or more objects.

In some implementations, the control module 506 controls the emission of pulses of light based on a distance between one or more points of interest and the vehicle 200. For instance, based on sensor data obtained from the additional sensor(s) 508 (e.g., location data obtained by the localization system 406), the control module 506 can determine the distance between a particular point of interest and the vehicle 200. Further, the control module 506 can control the frequency of the emitted pulses of light based on the distance. Example points of interests include buildings, landmarks, geographical features, businesses, or any other type of location.

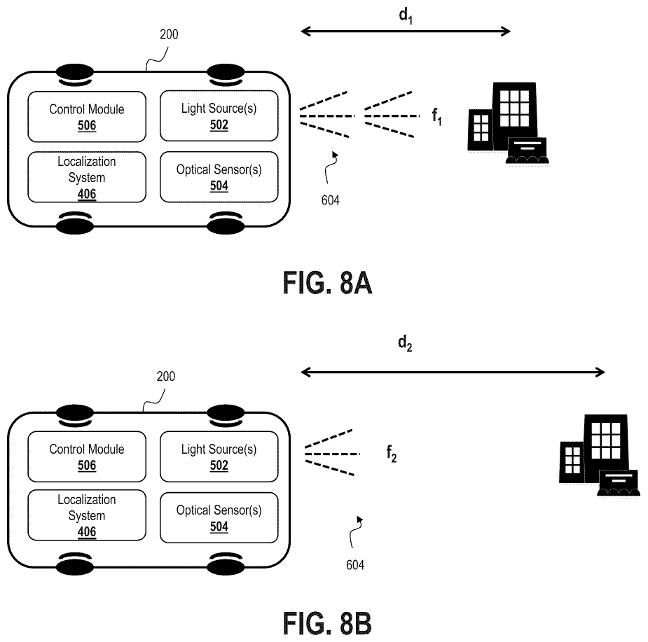

As an example, referring to FIG. 8A, the control module 506 obtains location data from the localization system 406, and determines that a point of interest 802 is positioned a distance d₁ from the vehicle 200. Based on this determination, the control module 506 instructs the light source(s) 502 to emit pulses of light 602 according to a first frequency f₁. Similarly, the control module 506 instructs the optical sensor(s) 504 to collect optical sensor data according to the first frequency f₁.

Further, referring to FIG. 8B, the control module 506 obtains radar location data from the localization system 406, and determines that the point of interest 802 is now positioned a farther distance d₂ from the vehicle 200. Based on this determination, the control module 506 instructs the light source(s) 502 to emit pulses of light 602 according to a second frequency f₂ less than the first frequency f₁. Similarly, the control module 506 instructs the optical sensor(s) 504 to collect optical sensor data according to the second frequency f₂.

This technique is beneficial, for example, in improving the operation of the vehicle 200. For example, if the vehicle 200 is positioned close to a point of interest 802, the optical imaging system 500 can collect optical sensor data more frequently to provide the vehicle 200 with more frequent feedback to navigate the vehicle 200 relative to the point of interest 802 (e.g., such that the vehicle can navigate more accurately or precisely). However, if the vehicle 200 is positioned far from a point of interest 802, the optical imaging system 500 can collect optical sensor data more infrequently (e.g., to converse resources, such as power or computational resources).

In some implementations, distance between the point of interest 802 and the vehicle 200 is inversely proportional to the frequency of the emitted light.

As described above, some implementations, the vehicle 200 uses the optical imaging system 500 to perform object detection and/or localization without the use of LiDAR sensor(s) 202b. This is advantageous, as LiDAR sensor(s) may be more expensive and/or complex to implement in a vehicle (e.g., compared to an optical imaging system 500). Nevertheless, in some implementations, the vehicle 200 uses the optical imaging system 500 in conjunction with LiDAR sensor(s) 202b and/or other sensor systems to perform object detection and/or localization (e.g., to increase the diversity of sensor data collected by the vehicle during operation).

For example, in some implementations, the control module 506 selectively activates the light source(s) 502 based on a velocity or speed of the vehicle 200. For instance, based on sensor data obtained from the additional sensor(s) 508 (e.g., velocity data obtained by a velocity sensor 902), the control module 506 can determine the velocity of the vehicle. Further, the control module 506 can selectively activate the light source(s) 502 when the velocity of the vehicle satisfies a particular threshold velocity (and disable one or more other sensors, such as LiDAR sensor(s) 202b). For example, the control module 506 can selectively activate the light source(s) 502 when the velocity of the vehicle is greater than a particular threshold velocity. Further, the control module 506 can selectively deactivate the light source(s) 502 when the velocity of the vehicle does not satisfy the threshold velocity (and activate one or more other sensors, such as LiDAR sensor(s) 202b). For example, the control module 506 can selectively deactivate the light source(s) 502 when the velocity of the vehicle is less than the threshold.

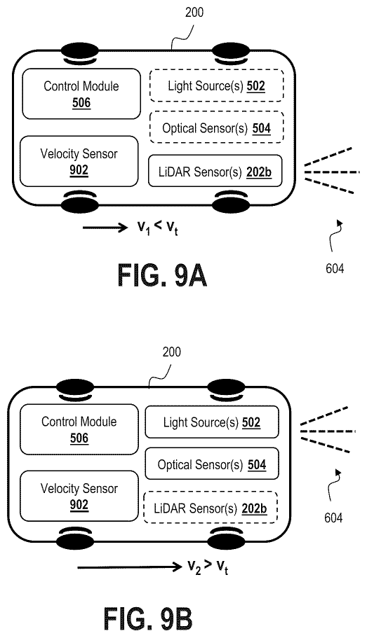

As an example, referring to FIG. 9A, the control module 506 obtains velocity data from a velocity sensor 902, and determines that the vehicle 200 is traveling at a first velocity v₁ that does not satisfy a threshold velocity vₜ. As an example, the control module 506 can determine that the first velocity v₁ is less than the threshold velocity vₜ. Based on this determination, the control module 506 deactivates the light source(s) 502 (e.g., such that the light source(s) 502 do not emit pulses of light), and activates the LiDAR sensor(s) 202b (e.g., to obtain sensor data regarding the environment). In some implementations, the control module 506 can also deactivate the optical sensor(s) 504 (e.g., such that no optical sensor data is collected).

Further, referring to FIG. 9B, the control module 506 obtains velocity data from the velocity sensor 902, and determines that the vehicle 200 is traveling at a second velocity v₂ satisfies the threshold velocity vₜ. As an example, the control module 506 can determine that the second velocity v₂ is greater than the threshold velocity vₜ. Based on this determination, the control module 506 activates the light source(s) 502 (e.g., such that the light source(s) 502 emit pulses of light) and the optical sensor(s) 504 (e.g., such that optical sensor data is collected). Further, the control module 506 deactivates the LiDAR sensor(s) 202b.

This technique is beneficial, for example, in improving the operation of the vehicle 200. For example, under some circumstances, the optical imaging system 500 may be better suited to obtain sensor data regarding the environment than the LiDAR sensor(s) 202b (e.g., while the vehicle 2000 is traveling at to a sufficiently high velocity). Further, under other circumstances, the LiDAR sensors 202b may be better suited to obtain sensor data regarding the environment than the optical imaging system 500 (e.g., while the vehicle 2000 is traveling at to a sufficiently low velocity). Further, due to the emission of light by the light source(s) 502 and the LiDAR sensor(s) 202b, concurrently operating the optical imaging system 500 and the LiDAR sensor(s) 202b may interfere with the operation of each (e.g., due to constructive and/or destructive light interference). Accordingly, the vehicle 200 can selectively switch between the optical imaging system 500 and the LiDAR sensor(s) 202b to better obtain sensor data regarding the environment and/or avoid interference between the optical imaging system 500 and the LiDAR sensor(s) 202b.

In practice, the threshold velocity v t can be selected empirically. For example, the threshold velocity v t can be selected based on experiments or studies conducted regarding the effectiveness of the optical imaging system 500 and the LiDAR sensor(s) 202b at different vehicle velocities.

In some implementations, the control module 506 selectively activates the light source(s) 502 based on the ambient light in the environment. For instance, based on sensor data obtained from the additional sensor(s) 508 (e.g., ambient light data obtained by an ambient light sensor 1002), the control module 506 can determine the ambient light the environment. Further, the control module 506 can selectively activate the light source(s) 502 when the intensity of the ambient light does not satisfy a particular threshold intensity (and disable one or more other sensors, such as LiDAR sensor(s) 202b). Further, the control module 506 can selectively deactivate the light source(s) 502 when the intensity of the ambient light satisfies the threshold intensity (and activate one or more other sensors, such as LiDAR sensor(s) 202b). As an example, the control module 506 can selectively activate the light source(s) 502 when the intensity of the ambient light is less than a particular threshold intensity, and selectively deactivate the light source(s) 502 when the intensity of the ambient light is greater than the threshold intensity.

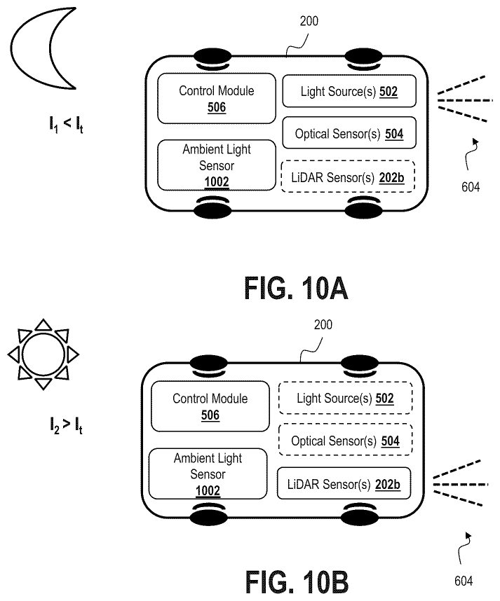

As an example, referring to FIG. 10A, the control module 506 obtains ambient light data from an ambient light sensor 1002, and determines that the intensity of ambient light in the environment of the vehicle 200 is a first intensity I₁ less than a threshold intensity Iₜ. Based on this determination, the control module 506 deactivates the light source(s) 502 (e.g., such that the light source(s) 502 do not emit pulses of light), and activates the LiDAR sensor(s) 202b (e.g., to obtain sensor data regarding the environment). In some implementations, the control module 506 can also deactivate the optical sensor(s) 504 (e.g., such that no optical sensor data is collected).

Further, referring to FIG. 10B, the control module 506 obtains ambient light data from an ambient light sensor 1002, and determines that the intensity of ambient light in the environment of the vehicle 200 is a second intensity 12 greater than the threshold intensity Iₜ. Based on this determination, the control module 506 activates the light source(s) 502 (e.g., such that the light source(s) 502 emit pulses of light) and the optical sensor(s) 504 (e.g., such that optical sensor data is collected). Further, the control module 506 deactivates the LiDAR sensor(s) 202b.

This technique is beneficial, for example, in improving the operation of the vehicle 200. For example, under some circumstances (e.g., during low ambient light conditions), the optical imaging system 500 may be better suited to obtain sensor data regarding the environment than the LiDAR sensor(s) 202b. Further, under other circumstances (e.g., during high ambient light conditions), the LiDAR sensors 202b may be better suited to obtain sensor data regarding the environment than the optical imaging system 500. Further, due to the emission of light by the light source(s) 502 and the LiDAR sensor(s) 202b, concurrently operating the optical imaging system 500 and the LiDAR sensor(s) 202b may interfere with the operation of each (e.g., due to constructive and/or destructive light interference). Accordingly, the vehicle 200 can selectively switch between the optical imaging system 500 and the LiDAR sensor(s) 20b to better obtain sensor data regarding the environment.

In practice, the threshold intensity Iₜ can be selected empirically. For example, the threshold intensity Iₜ can be selected based on experiments or studies conducted regarding the effectiveness of the optical imaging system 500 and the LiDAR sensor(s) 202b at different intensities of ambient light).

According to some non-limiting embodiments or examples, provided is a system for obtaining optical sensor data of an environment of an autonomous vehicle, the system comprising: a light source; an optical sensor; and a control module communicatively coupled to the light source and the optical sensor, wherein the light source is configured to periodically emit pulses of light into the environment of the autonomous vehicle, wherein the optical sensor is configured to periodically obtain the optical sensor data of the environment of the autonomous vehicle, and wherein the control module is configured to: obtain additional sensor data from one or more additional sensors, the additional sensor data representing at least one of a characteristic of the autonomous vehicle or a characteristic of the environment of the autonomous vehicle, and control an operation of the light source based on the additional sensor data.

Further non-limiting aspects or embodiments are set forth in the following numbered clauses:

Clause 1: A system for obtaining optical sensor data of an environment of an autonomous vehicle, the system comprising: a light source; an optical sensor; and a control module communicatively coupled to the light source and the optical sensor, wherein the light source is configured to periodically emit pulses of light into the environment of the autonomous vehicle, wherein the optical sensor is configured to periodically obtain the optical sensor data of the environment of the autonomous vehicle, and wherein the control module is configured to: obtain additional sensor data from one or more additional sensors, the additional sensor data representing at least one of a characteristic of the autonomous vehicle or a characteristic of the environment of the autonomous vehicle, and control an operation of the light source based on the additional sensor data.

Clause 2: The system of Clause 1, wherein the light source and the optical sensor is secured to the autonomous vehicle.

Clause 3: The system of any of Clauses 1 and 2, where the optical sensor data comprises at least one of an image or a video.

Clause 4: The system of any of Clauses 1-3, wherein the additional sensor data represents a distance between the autonomous vehicle and an object in the environment of the autonomous vehicle, and wherein controlling the operation of the light source comprises selecting at least one of a power or an intensity of the pulses of light based on the distance between the autonomous vehicle and the object.

Clause 5: The system of Clause 4, wherein the one or more additional sensors comprises a radar sensor.

Clause 6: The system of any of Clauses 4 and 5, wherein controlling the operation of the light source comprises: responsive to determining that the distance between the autonomous vehicle and the object has increased, increasing at least one of the power or the intensity of the pulses of light.

Clause 7: The system of any of Clauses 4-6, wherein controlling the operation of the light source comprises: responsive to determining that the distance between the autonomous vehicle and the object has decreased, decreasing at least one of the power or the intensity of the pulses of light.

Clause 8: The system of any of Clauses 1-7, wherein the additional sensor data represents a distance between the autonomous vehicle and a point of interest in the environment of the autonomous vehicle, and wherein controlling the operation of the light source comprises selecting a frequency of the pulses of light based on the distance between the autonomous vehicle and the point of interest.

Clause 9: The system of Clause 8, wherein the one or more additional sensors comprises at least one of a navigation system or a mapping system.

Clause 10: The system of any of Clauses 8 and 9, wherein controlling the operation of the light source comprises: responsive to determining that the distance between the autonomous vehicle and the point of interest has increased, decreasing the frequency of the pulses of light.

Clause 11: The system of any of Clauses 8-10, wherein controlling the operation of the light source comprises: responsive to determining that the distance between the autonomous vehicle and the point of interest has decreased, increasing the frequency of the pulses of light.

Clause 12: The system of any of Clauses 1-11, wherein the additional sensor data represents a velocity of the autonomous vehicle, and wherein controlling the operation of the light source comprises selectively activating or deactivating the light source based on the velocity of the autonomous vehicle.

Clause 13: The system of Clause 12, wherein the one or more additional sensors comprises a velocity sensor.

Clause 14: The system of any of Clauses 12 and 13, wherein controlling the operation of the light source comprises: responsive to determining that the velocity of the autonomous vehicle is greater than a threshold velocity, activating the light source.

Clause 15: Clauses responsive to determining that the velocity of the autonomous vehicle is greater than the threshold velocity, deactivating a LiDAR sensor of the autonomous vehicle.

Clause 16: The system of any of Clauses 12-15, wherein controlling the operation of the light source comprises: responsive to determining that the velocity of the autonomous vehicle is less than a threshold velocity, deactivating the light source.

Clause 17: The system of Clause 16, further comprising: responsive to determining that the velocity of the autonomous vehicle is less than the threshold velocity, activating a LiDAR sensor of the autonomous vehicle.

Clause 18: The system of any of Clauses 1-17, wherein the additional sensor data represents an intensity of ambient light in the environment, and wherein controlling the operation of the light source comprises selectively activating or deactivating the light source based on the intensity of ambient light in the environment.

Clause 19: The system of Clause 18, wherein the one or more additional sensors comprises an ambient light sensor.

Clause 20: The system of any of Clauses 18 and 19, wherein controlling the operation of the light source comprises: responsive to determining that the intensity of ambient light in the environment is less than a threshold intensity, activating the light source.

Clause 21: The system of any of Clauses 18-20, wherein controlling the operation of the light source comprises: responsive to determining that the intensity of ambient light in the environment is greater than a threshold intensity, deactivating the light source.

Claim 22: The system of any of Clauses 1-21, further comprising one or more processors configured to: receive the optical sensor data, and determine, based on the optical sensor data, at least one of: a location of an object in the environment of the autonomous vehicle, an orientation of the object in the environment of the autonomous vehicle, Clauses an orientation of the autonomous vehicle in the environment.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A system for obtaining optical sensor data of an environment of an autonomous vehicle, the system comprising:
a light source;
an optical sensor; and
a control module communicatively coupled to the light source and the optical sensor,
wherein the light source is configured to periodically emit pulses of light into the environment of the autonomous vehicle,
wherein the optical sensor is configured to periodically obtain the optical sensor data of the environment of the autonomous vehicle, and
wherein the control module is configured to:
obtain additional sensor data from one or more additional sensors, the additional sensor data representing at least one of a characteristic of the autonomous vehicle or a characteristic of the environment of the autonomous vehicle, and
control an operation of the light source based on the additional sensor data.

2. The system of claim 1, wherein the light source and the optical sensor is secured to the autonomous vehicle.

3. The system of claim 1, where the optical sensor data comprises at least one of an image or a video.

4. The system of claim 1, wherein the additional sensor data represents a distance between the autonomous vehicle and an object in the environment of the autonomous vehicle, and
wherein controlling the operation of the light source comprises selecting at least one of a power or an intensity of the pulses of light based on the distance between the autonomous vehicle and the object.

5. The system of claim 4, wherein the one or more additional sensors comprises a radar sensor.

6. The system of claim 4, wherein controlling the operation of the light source comprises:
responsive to determining that the distance between the autonomous vehicle and the object has increased, increasing at least one of the power or the intensity of the pulses of light.

7. The system of claim 4, wherein controlling the operation of the light source comprises:
responsive to determining that the distance between the autonomous vehicle and the object has decreased, decreasing at least one of the power or the intensity of the pulses of light.

8. The system of claim 1, wherein the additional sensor data represents a distance between the autonomous vehicle and a point of interest in the environment of the autonomous vehicle, and
wherein controlling the operation of the light source comprises selecting a frequency of the pulses of light based on the distance between the autonomous vehicle and the point of interest.

9. The system of claim 8, wherein the one or more additional sensors comprises at least one of a navigation system or a mapping system.

10. The system of claim 8, wherein controlling the operation of the light source comprises:
responsive to determining that the distance between the autonomous vehicle and the point of interest has increased, decreasing the frequency of the pulses of light.

11. The system of claim 8, wherein controlling the operation of the light source comprises:
responsive to determining that the distance between the autonomous vehicle and the point of interest has decreased, increasing the frequency of the pulses of light.

12. The system of claim 1, wherein the additional sensor data represents a velocity of the autonomous vehicle, and
wherein controlling the operation of the light source comprises selectively activating or deactivating the light source based on the velocity of the autonomous vehicle.

13. The system of claim 12, wherein the one or more additional sensors comprises a velocity sensor.

14. The system of claim 12, wherein controlling the operation of the light source comprises:
responsive to determining that the velocity of the autonomous vehicle is greater than a threshold velocity, activating the light source.

15. The system of claim 14, further comprising:
responsive to determining that the velocity of the autonomous vehicle is greater than the threshold velocity, deactivating a LiDAR sensor of the autonomous vehicle.

16. The system of claim 12, wherein controlling the operation of the light source comprises:
responsive to determining that the velocity of the autonomous vehicle is less than a threshold velocity, deactivating the light source.

17. The system of claim 16, further comprising:
responsive to determining that the velocity of the autonomous vehicle is less than the threshold velocity, activating a LiDAR sensor of the autonomous vehicle.

18. The system of claim 1, wherein the additional sensor data represents an intensity of ambient light in the environment, and
wherein controlling the operation of the light source comprises selectively activating or deactivating the light source based on the intensity of ambient light in the environment.

19. The system of claim 18, wherein the one or more additional sensors comprises an ambient light sensor.

20. The system of claim 18, wherein controlling the operation of the light source comprises:
responsive to determining that the intensity of ambient light in the environment is less than a threshold intensity, activating the light source.

21. The system of claim 18, wherein controlling the operation of the light source comprises:
responsive to determining that the intensity of ambient light in the environment is greater than a threshold intensity, deactivating the light source.

22. The system of claim 1, further comprising one or more processors configured to:
receive the optical sensor data, and
determine, based on the optical sensor data, at least one of:
a location of an object in the environment of the autonomous vehicle,
an orientation of the object in the environment of the autonomous vehicle,
a location of the autonomous vehicle in the environment, or
an orientation of the autonomous vehicle in the environment.
